(19) United States
(12) Patent Application Publication
(10) Pub. No.: US 2017/0086448 A1
(43) Pub. Date: Mar. 30, 2017

(54) FLYING INSECT TRAP WITH ROLLER ADVANCE

(71) Applicant: GARDNER MANUFACTURING CO., INC., Horicon, WI (US)

(72) Inventors: Bruce R. Studer, Germantown, WI (US); Timothy M. Jones, Phoenix, AZ (US)

(21) Appl. No.: 14/867,546

(22) Filed: Sep. 28, 2015

(51) Int. Cl. A01M 1/14; A01M 1/02; A01M 1/10; A01M 1/04

(52) U.S. Cl. CPC A01M 1/145; A01M 1/04; A01M 1/02; A01M 1/10

(57) ABSTRACT

An insect trap which includes an enclosure with a removable cover member having at least one opening therethrough and contained within the enclosure is an insect attractant, a take-up roller, a supply roller, each journaled for rotation about parallel, spaced-apart axes, and where a flexible web is wound on the supply roller and transferrable onto the take-up roller. The web has an adhesive on one major surface. Also contained within the enclosure is an electric motor connected in driving relation to the take-up roller and a timer circuit for controlling the ON/OFF state of the electric motor. The timer circuit is designed such that when switched to the “on” state, remains on only long enough to transfer a quantity of the web in a range of plus or minus 10% of the predetermined length dimension between the two rollers before assuming the “off” state.

### CROSS-REFERENCED TO RELATED APPLICATIONS

Not applicable

### STATEMENT REGARDING FEDERALLY SPONSORED RESEARCH OR DEVELOPMENT

Not applicable

### BACKGROUND OF THE INVENTION

I. Field of the Invention

The present invention relates generally to devices for trapping insects having an insect attractant contained within a decorative housing along with an insect neutralizer in the fowl of an adhesive coated substrate and more particularly to an insect trap in which the insect neutralizer surface is automatically replaced at predetermined, pre-programmed intervals.

II. Discussion of the Prior Art

In our earlier U.S. Pat. No. 6,886,292 there is described an insect trap which includes a base having a rear surface and a front surface, a housing mounted to cover at least a portion of the front surface of the base, an insect attractant such as a light located at least partially within the housing, an insect neutralizer such as an adhesive surface located at least partially within the housing, and an electrical plug protruding from the rear surface of the base whereby the insect trap may be mounted to an electrical socket by inserting the electrical plug into the electrical socket. The insect trap can be easily mounted and removed, making it suitable for intermittent, seasonal, or temporary use.

While the '292 patent describes a preferred embodiment that constitutes an advance in the art, it requires frequent periodic maintenance to replace the adhesive surface, sometimes referred to as a glue board, in that it becomes overly populated with dead insects and becomes incapable of performing its intended function. A need therefore exists for an insect trap of the type described that automatically replaces a used adhesive surface with a fresh one at periodic selectable intervals. The frequency of replacement should be selectable in that the insect population tends to he seasonal, especially in more northern climates in the U.S. and in Europe. Replacement of the adhesive surface in summer months must be more frequent than in winter months. The present invention addresses the stated need.

### SUMMARY OF THE INVENTION

The insect trap constituting a preferred embodiment of the present invention comprises an enclosure having a substantially planar rear surface and a removable front cover member that has one or more openings therethrough. Disposed within the enclosure is an insect attractant for enticing insects through the opening(s) and into the interior of the enclosure. Also disposed in the enclosure is a take-up roller and a supply roller, the two being journaled for rotation about parallel, spaced-apart axes where the spacing is a predetermined length dimension. A flexible web is wound on the supply roller and the web is transferrable onto the take-up roller. The web has a coating of an adhesive on one major surface thereof Operatively coupled to the take-up roller is an electric motor and coupled in controlling relation to the motor is a timer circuit for establishing the “on” and “off” states for the motor. A controller is coupled to the timer circuit for initiating operation of the timer circuit “on” state at selectable frequencies. Each time the motor is turned on, it advances the web through a distance or length corresponding to the predetermined spacing between the supply roller and the take-up roller.

### DESCRIPTION OF THE DRAWINGS

The foregoing features, objects and advantages of the invention will become apparent to those skilled in the art from the following detailed description of a preferred embodiment, especially when considered in conjunction with the accompanying drawings in which like numerals in the several views refer to corresponding parts.

FIG. 1 is a front perspective view of an insect trap comprising a preferred embodiment of the invention;

FIG. 2 is a perspective frontal view like that of FIG. 1 but with the cover removed to reveal the internal construction;

FIG. 3 is a side elevation of the enclosure with the cover off and showing the direction of movement of the web upon actuation of the drive motor;

FIG. 4 is a general block diagram of the electrical circuitry involved; and

FIG. 5 is a detailed block diagram for the control module shown in FIG. 4.

### DESCRIPTION OF THE PREFERRED EMBODIMENT

This description of the preferred embodiments is intended to be read in connection with the accompanying drawings, which are to be considered part of the entire written description of this invention. In the description, relative terms such as “lower”, “upper”, “horizontal”, “vertical”, “above”, “below”, “up”, “down”, “top” and “bottom” as well as derivatives thereof (e.g., “horizontally”, “downwardly”, “upwardly”, etc.) should be construed to refer to the orientation as then described or as shown in the drawings under discussion. These relative terms are for convenience of description and do not require that the apparatus be constructed or operated in a particular orientation. Terms such as “connected”, “connecting”, “attached”, “attaching”, “join” and “joining” are used interchangeably and refer to one structure or surface being secured to another structure or surface or integrally fabricated in one piece, unless expressively described otherwise.

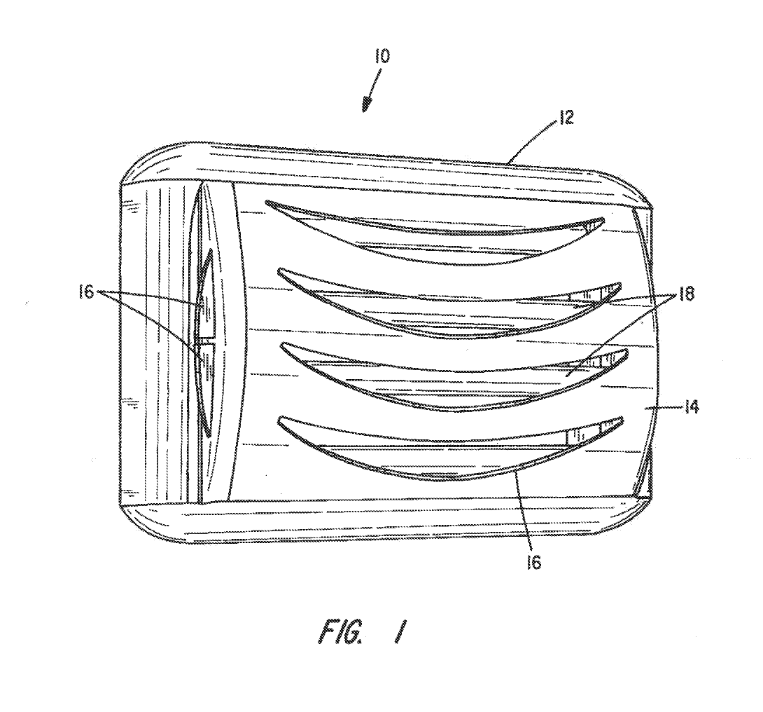

In FIG. 1, the insect trap of the present invention is identified generally by numeral 10 and is seen to include a two-piece enclosure including a molded plastic back member 12 and a snap-on, snap-off removable front cover 14, preferably of a polished aluminum. Painted aluminum or other materials may be used without deviating from the invention. Without limitation, the enclosure may be approximately 23 inches wide, 11.25 inches high and 4 inches deep. The back member 12 has a planar rear surface to facilitate its being mounted on a wall or ceiling surface of a room. The polished aluminum cover member 14 includes at least one and preferably several openings, as at 16, formed therethrough to permit entry of insects into the interior of the enclosure.

Visible through the openings 16 are insect attractant members 18 which are preferably ultraviolet light sources, but alternatively may comprise a pheromone or lure of a type known to attract flying insects.

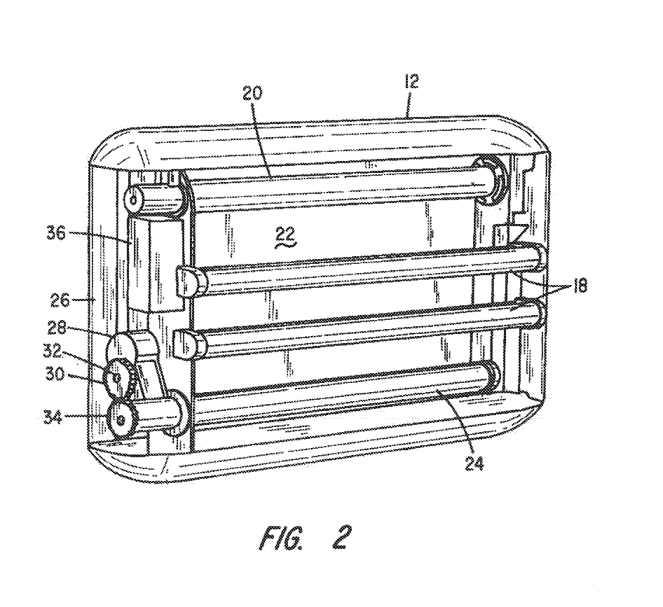

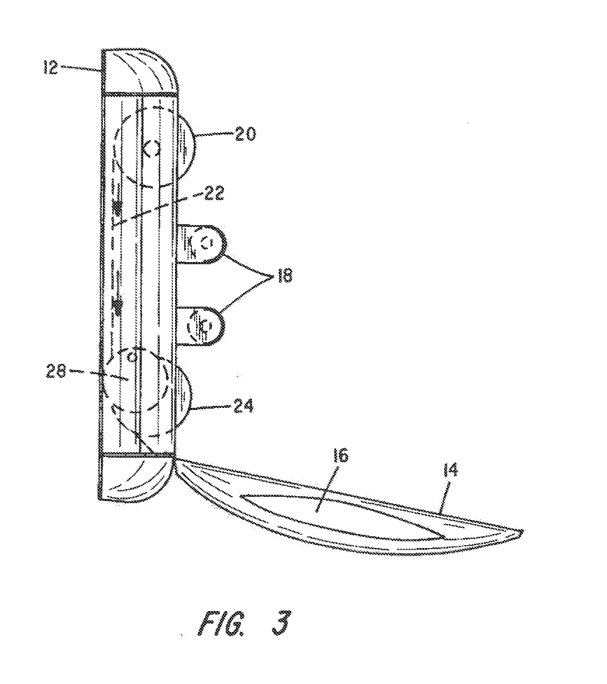

Referring next to FIG. 2, it can be seen that journaled for rotation between the left and right sidewalls of the back member 12 of the enclosure proximate its upper end is a supply roller 20 on which is wound a web 22 of a flexible material, the web also being wrapped about a take-up roller 24 located proximate the bottom end of the enclosure 12. Again, without limitation, the axis of the supply roller 20 may be approximately 9 inches from the axis of the take-up roller 24 and the width of the web may be approximately 16 inches. An exposed major surface of the web 22 is coated with a suitable adhesive to function as an insect capture surface. Mounted to the left sidewall 26 of the enclosure is an electric motor 28 having a spur gear 30 affixed to its output shaft 32. The spur gear 30 is arranged to mesh with a further spur gear 34 on the take-up roller 24.

Also mounted on the left sidewall 26 of the enclosure back member 12 is an electronics circuit module 36 for controlling the ON/OFF state of the motor 28. As will be explained in detail below, at periodic, selectable intervals, the controller 36 will function to energize the motor 28 for a defined period of time sufficient to replace the length of the web that is exposed between the supply roller 20 and the take-up roller 24, at which point the controller again turns off the motor.

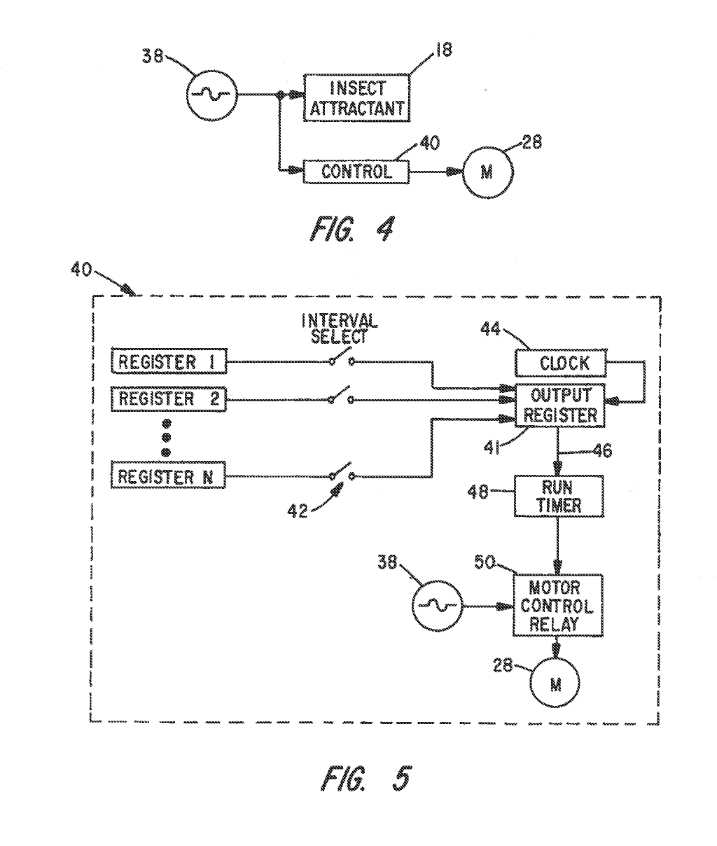

As is indicated in FIG. 4, the insect trap of the present invention is adapted to be driven from a voltage source 38 and is used to power the insect attractant 18 which, as earlier stated, may comprise ultraviolet bulbs, a pheromone designed to give off a scent, especially when warmed as by a suitably designed electrical resistance element, or other lure. The voltage source 38 is also applied to the control module 40 for the motor 28.

As indicated earlier, it is a feature of the present invention that a fresh web segment, free of insects, be drawn from the supply roller 20 at preset, selectable intervals and with the insect-laden segment of web wound up on the take-up roller 24 and thereby encapsulating the dead insects. The controller should also function to only draw a length of web from the supply roller sufficient to span the distance between the axis of the supply roller 20 and that of the take-up roller 24 within a tolerance of, say, plus or minus 10%. The control module 40 shown in FIG. 5 is designed to achieve this result.

Referring to FIG. 5, there is provided a read-only memory, here shown as comprising a plurality of hardwired registers labeled “Register 1” through “Register N”, each storing a digital value representative of a different predetermined time interval. For example, Register 1 may contain a digital value corresponding to a 15-day period, Register 2 a value corresponding to a 30-day period and Register N of a still different period. A user may select which of the several registers is to be used to load the Output register 41 by closing one of the interval select switches 42. With a time interval loaded into the Output register, the digital value so entered will be decremented by a crystal controlled clock circuit 44 and when the content of the Output register 41 is decremented to zero, it will emit a trigger pulse on line 46 to initiate the Run Timer 48 which typically will constitute a one-shot circuit, causing it to change state for a predetermined time period before reverting to its initial state. The output from the Run Timer 48 actuates a motor control relay 50 which serves to connect the power source 38 to the motor 28 for a time just sufficient to draw a fresh length of the web from the supply roller to the take-up roller.

It is further contemplated that instead of using a one-shot circuit to establish the desired motor run time for delivering a measured quantity of web material, the same result may be achieved by having fiducial markings on the web at equally spaced intervals corresponding to the distance between the supply and take-up rollers and using an optical sensor for detecting the markings and shutting off the motor. In this arrangement, the motor 28 will be turned on by the signal from the output register 41 upon its contents being decremented to zero and will be turned off by an output from the optical sensor upon its detection of a next fiducial mark on the web as it moves into view of the sensor.

This invention has been described herein in considerable detail in order to comply with the patent statutes and to provide those skilled in the art with the information needed to apply the novel principles and to construct and use such specialized components as are required. However, it is to be understood that the invention can be carried out by specifically different equipment and devices. For example, persons skilled in the art may implement the control 40 in a variety of ways including a programmed microcontroller for carrying out the functionality described. Also, various modifications, both as to the equipment and operating procedures, can be accomplished without departing from the scope of the invention itself For example, the enclosure may also be designed to accept a conventional glue board. A braking element may also be adapted to provide a drag on the supply roller to ensure only the desired amount of the web is pulled from the supply roller as the motor runs.

What is claimed is:

1. An insect trap comprising:
(a) an enclosure having a substantially planar rear surface and a removable front cover member, the cover member having at least one opening;
(b) an insect attractant contained within the enclosure for attracting insects through the at least one opening;
(c) a take-up roller and a supply roller journaled for rotation within the enclosure, said take-up roller and supply roller being parallel to one another and in spaced-apart relation by a predetermined length dimension;
(d) a flexible web wound on the supply roller and transferable onto the take-up roller, the web having an adhesive on one major surface thereof;
(e) an electric motor connected in driving relation to the take-up roller; and
(f) means for controlling the on-off state of the electric motor, when the motor is periodically turned on at a preselected interval and turns off automatically when a predetermined quantity of the web corresponding to the predetermined length dimension has been advanced onto the take-up roller.

2. The insect trap as in claim 1 wherein the means for controlling the on-off state of the electric motor comprises a timer circuit.

3. The insect trap as in claim 1 wherein the timer circuit, when switched to the “on” state, remains on only long enough to transfer a quantity of the web in a range of ±10 percent of the predetermined length dimension before assuming the “off” state.

4. The insect trap of claim 3 wherein the timer circuit includes means for setting the frequency that the timer circuit switches to the “on” state.

5. The insect trap of claim 1 wherein the insect attractant comprises a light source.

6. The insect trap of claim 1 wherein the insect attractant comprises a pheromone.

7. The insect trap of claim 5 wherein the light source comprises an ultraviolet bulb.

8. The insect trap of claim 1 wherein the predetermined length dimension is in a range of from 6-12 inches.

9. The insect trap of claim 4 wherein the means for setting the frequency that the timer circuit switches to the “on” state comprises:
(a) a plurality of data storage registers adapted to store digital values representative of predetermined time intervals;
(b) an output register;
(c) switch means for selectively connecting one of the plurality of data storage registers to the output register for loading the digital value stored in said one of the plurality of data storage registers into the output register; and
(d) a clock circuit connected to the output register and operative to decrement the digital value entered therein and producing an output trigger signal upon the decremented digital value reaching a predetermined count value.

10. The insect trap of claim 9 and further including a one-shot circuit coupled to receive the trigger signal, said one-shot circuit controlling the run time of said electric motor.
